(19) United States
(12) Patent Application Publication
(10) Pub. No.: US 2003/0182652 A1
(43) Pub. Date: Sep. 25, 2003

(54) Software building and deployment system and method

(76) Inventor: Gabriel T. Custodio, Pyrmont (AU)

Correspondence Address: Beck & Tysver, P.L.L.C., Suite 100, 2900 Thomas Avenue S., Minneapolis, MN, 55416, US

(21) Appl. No.: 10/328,511

(22) Filed: Dec. 23, 2002

Related U.S. Application Data
(60) Provisional application No. 60/343,082, filed on Dec. 21, 2001.
(60) Provisional application No. 60/366,473, filed on Mar. 20, 2002.

(51) Int. Cl. G06F 17/30; G06F 12/00; G06F 9/44

(52) U.S. Cl. 717/122; 717/170

(57) ABSTRACT

A software building and deployment system and related method are presented that automates interactions with a source code repository system, an external builder, and a content deployment system. All interactions with these components are under the control of a manifest, and are recorded in a central database. This database maintains a link between source code in the repositories and the code and content actual deployed in an environment, such as a testing environment or a production environment. Each manifest is assigned a release number to allow the database to track every change to an environment as separate release. This in turn allows the database to track the entire contents of an environment over time, down to the exact version of a component found in a particular release of the environment. The present invention uses this information to perform environment rollbacks to a prior release. Finally, the present invention creates a CRC value for every file that is deployed to an environment, which allows the system to determine whether any changes have been made to a deployed file during deployment or since the last deployment.

### CLAIM OF PRIORITY

This application claims priority to provisional patent applications U.S. Serial No. 60/343,082, filed on Dec. 21, 2001, and U.S. Ser. No. 60/366,473, filed on Mar. 20, 2002, both of which are hereby incorporated by reference in their entirety.

### Reference to Computer Program Listing Appendix on Compact Disc

This specification contains a computer program listing appendix which has been submitted in a CDR compact disc. The files on that disc are Release.txt (28 KB), Rollback.txt (12 KB), and ServPak.txt (16 KB), all of which were created on Dec. 23, 2002. The computer program listing appendix found in these files are hereby incorporated by reference in their entirety.

### FIELD OF THE INVENTION

This invention relates to the field of software deployment systems. More particularly, the present invention relates to a system and method automatically building, deploying, and rolling back software.

### BACKGROUND OF THE INVENTION

It is often a challenge to successfully compile and deploy software in a consistent and predictable manner. In prior art systems, source code repository systems are used for the storage and version tracking of source code. These systems allow a user to check software into and out of the system, track versions, maintain security, and monitor dependencies between code segments. When the code is ready to be compiled, the source code is checked out and submitted to a building engine for compilation. The compiled code is then usually deployed into a development, testing, or production environment, depending on the current status of the developed code. This deployment is typically accomplished by placing the compiled code in a staging directory used by a content deployment and replication engine. By placing the code in the correct location of the staging directory, the deployment and replication engine can determine the locations to which the compiled code should be deployed. In addition, non-compiled data (such as content and third party executables) can also be stored in a source code repository and deployed by a content deployment and replication engine. Of course, such non-compiled data would not need to be operated upon by a compiler.

Unfortunately, no prior art system adequately integrates source code repositories, compilers, and deployment engines. As a result, the delivery of new software components and updates to the development, testing, and production environments is often inconsistent, error laden, and time consuming. It takes hours, sometimes even days, before a new working version of an application or an update can be deployed into a specified environment. And most challenging of all is when it becomes necessary to rollback the entire environment into the last working version when particular updates do not work. Because there is no adequate integration of these tools, the coordination of source code, building, and deployment and the handling of rollbacks are accomplished, at least in part, manually. This manual effort is a test of patience, concentration, and precision. The slightest mistake can render a site unusable until it is fixed.

Adding more complexity is the fact that there is no effective versioning convention for the deployed software. Prior art systems focus on version control for source code only, but do not carefully maintain version information for the code and content deployed into an environment. As a result, tracking the components that exist in an environment can be quite difficult. Finally, there is no effective way a full component inventory can be obtained from any environment. Without such an inventory, the integrity of the environments cannot be guaranteed and can only be accepted as is. This often results in unpredictable application behavior when components are moved between the development, testing, and production environments.

### SUMMARY OF THE INVENTION

The present invention overcomes these limitations in the prior art by providing a technique to efficiently integrate source code repository systems, external builders, and content deployment systems. The present invention accomplishes this by automating all interactions with these tools and by recording each interaction in a central database. This database allows the present invention to maintain a link between source material stored in the repositories and the code and content actually deployed on individual servers throughout all environments.

In addition, the present invention utilizes the concept of a manifest to handle all deployments to an environment. Each manifest is assigned a release number or identifier, so that each change to an environment is considered a separate release tracked in the central database. This gives the present invention the ability to track the exact version of all files that exist in a particular environment for a particular release, which allows the ability to easily rollback an environment to any known prior release of the environment.

Finally, the present invention creates a hash, or CRC, value for every file that is deployed through the system. This hash value is stored within the central database and is associated with a particular released version of a file. The present invention utilizes endpoint server inventory software operating on target servers to then create hash values for the files found on that server. These hash values are then returned to the present invention system, where they are compared with the expected hash value found in the central database. Inequalities result in errors, which can lead to the notification of responsible parties or to a redeployment of the release. Periodic inventories of the files located in an environment can be compared to the expected inventories found in the central database. Thus, the present invention will be aware if any of the files in an environment have been added, deleted, or altered outside of the control of the present invention. Since these unauthorized changes can lead to unpredictable results in the operation of the environment, the present invention will either notify a responsible party of their existence, or can automatically restore the environment to its expected state.

### BRIEF DESCRIPTION OF THE DRAWINGS

FIG. 1 is a schematic diagram showing the setting in which the software building and deployment system of the present invention is situated.

FIG. 2 is a series of schematic drawings each showing a manifest or rollback request along with the resulting state of the corresponding environment.

FIG. 3 is a schematic drawing showing the major modules of the present invention and the major external components that interface with the present invention.

FIG. 4 is a simplified database structure for the preferred database of the present invention.

FIG. 5 is a detailed database structure for the preferred database of the present invention.

FIG. 6 is an alternative embodiment to the database structure of FIG. 4.

FIG. 7 is a schematic drawing of a manifest as used by the present invention.

FIG. 8 is a flowchart for a manifest module used in the present invention.

FIG. 9 is a flowchart for a source control module used in the present invention.

FIG. 10 is a flowchart for an auto-build module used in the present invention.

FIG. 11 is a flowchart for a deployment module used in the present invention.

FIG. 12 is a flowchart for an inventory manager used in the present invention.

FIG. 13 is a flowchart for accomplishing a rollback using in the present invention.

### DETAILED DESCRIPTION OF THE INVENTION

1. Setting for the Invention

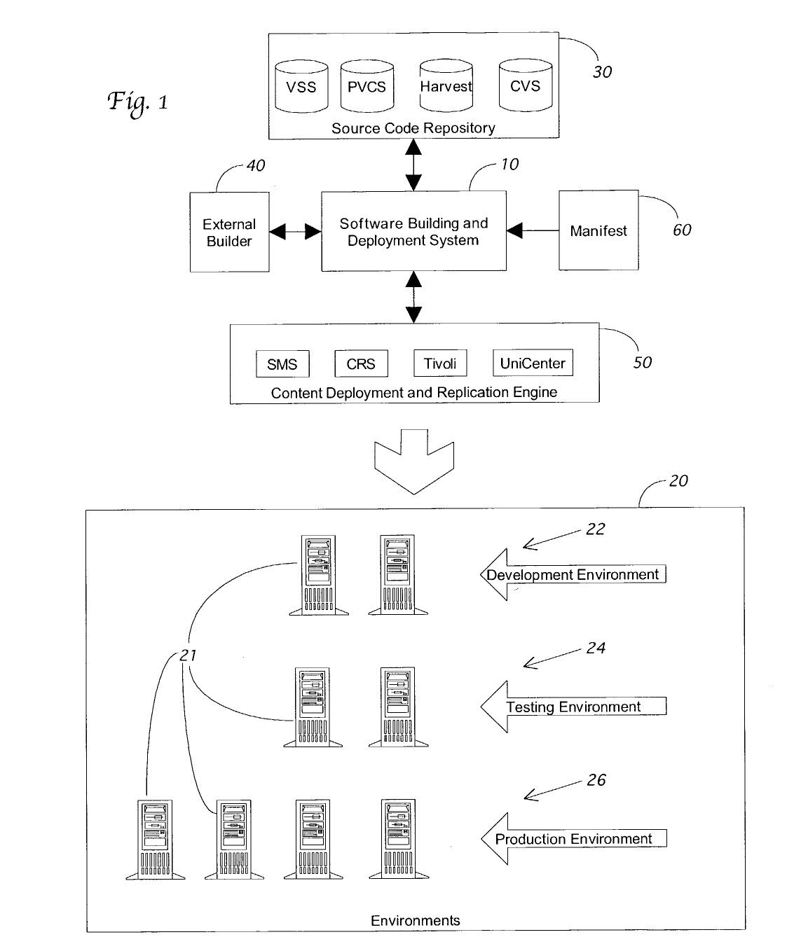

FIG. 1 shows a software building and deployment system 10 of the present invention. This system 10 manages the deployment of software and content to one or more environments 20. FIG. 1 shows three different environments 20, namely a development environment 22, a testing environment 24, and a production environment 26. These three environments 20 generally related to different stages in the development of a single integrated system, such as a commercial web site or the back-office processing environment of a corporation. As could be expected by their titles, the development environment 22 is used in the initial development of software components. The testing environment 24 is used for testing the components created in the development environment 22. The production environment 26 is in actual use on real-world data. In the context of providing a commercial web site, the production environment 26 contains all of the code and content that hosts the web site for the public. The development and testing environments 22, 24 would never be accessible to the public. Ideally, the production environment 26 would not contain any code that had not been first tested in the testing environment 24, while the testing environment 24 would test code that was first developed and found to operate within the development environment 22.

A component is promoted from one environment 20 to another when that component meets the required quality assurance test criteria assigned to each particular environment 20. When the testing of a component is complete, the component is promoted to the next environment 20.

One or more servers 21 host each environment. The servers 21 might host a particular function for an environment, such as an application server, a web server, or a database server. These separate functions or classes are maintained in the preferred embodiment of the present invention as one or more server types. All servers 21 within the same server type would be expected to have the same content. By maintaining server types, the present invention can create a single deployment package that is applied to multiple servers 21 containing the same content. The present invention manages assets that are deployed to multiple server types, such as a COM component that is used by multiple types of servers 21. In addition, one server 21 may be a member of multiple web server classes. This allows, for instance, one physical server to contain multiple web sites, each deployed to different directories.

In the prior art, the graduation of code from one environment 22, 24 to the next 24, 26 would often lead to unpredictable results. This is because the code and content found in the new environment 24, 26 would be different than that in which the new code was tested in the prior environment 22, 24. It was very difficult to perfectly recreate the production environment 26 in the testing environment 24 or to recreate the testing environment 24 in the development environment 22, because the prior art did not have perfect knowledge of the code and content of any of the environments 20. Such knowledge is required before that environment 20 can be perfectly recreated in another environment 20 for development and testing purposes.

The present invention manages this by using the software building and deployment system 10 to handle all aspects of the deployment of software and content to the environments 20. This system 10 interfaces directly with one or more source code repository systems 30, such as Visual SourceSafe (Microsoft Corporation, Redmond, Wash.) PVCS (Merant, Inc., Hillsboro, Oreg.), Harvest (Computer Associates International, Inc, Islandia, N.Y.), and Concurrent Versions System (or CVS, open source project). These repositories 30 store source code and content, handle security, check-in and checkout of code, and control versioning. The present invention system also interfaces with external builders 40, which handle the compilation of source code. Finally, the present invention system 10 interfaces with content deployment and replication engines 50 which handle the actual movement of source code and content to the environments 20. Sample engines 50 that could function with the present invention system 10 include Microsoft's Systems Management Server (SMS) and Site Server (Microsoft Corporation, Redmond, Wash.), Tivoli (IBM, Armonk, N.Y.), and UniCenter (Computer Associates International, Inc., Islandia, N.Y.).

The present invention 10 controls interactions between source code repositories 30, external builders 40, and content deployment and replication engines 50 so as to manage all changes to one or more computing environments 20. In this way, every change to an environment 20 is handled and tracked by the system 10 as a separate release. In the preferred embodiment, the system 10 is instructed to create a new release in an environment 20 through a manifest 60. This manifest 60 includes the instructions necessary for the system 10 to select the correct source material from the repositories 30, compile the material if necessary using builder 40, and deploy the compiled versions to the appropriate environment 20 using a deployment and replication engine 50. All changes to any environment 20 are initiated by a manifest 60, and therefore each manifest 60 is considered to define a new release for the environment 20 specified by the manifest 60.

2. Releases

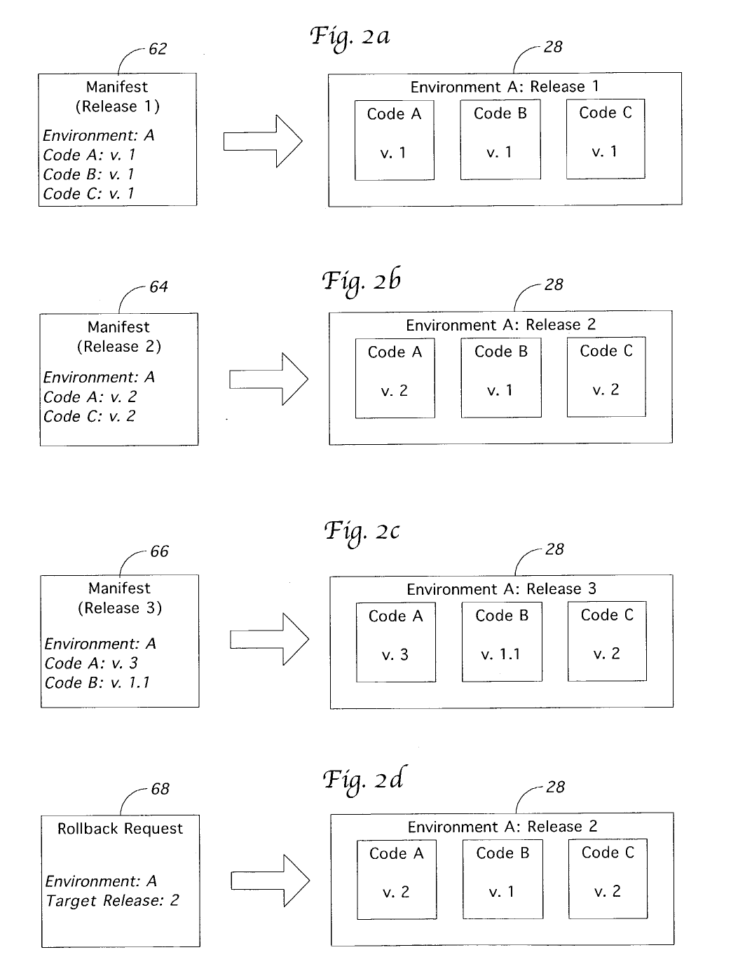

The use of releases to track changes in an environment 20 is seen more clearly in FIGS. 2a-2d. In FIG. 2a, a first manifest 62 specifies that code A, B, and C are to be deployed to environment A 28. More specifically, the manifest 62 specifies the exact version of the code that will be deployed. In this case, manifest 62 specifies that version 1 of A, B, and C should be deployed. The system 10 receives this manifest 62, and retrieves version 1 of code A, B, and C from the repositories 30. To the extent necessary, the system 10 will automatically compile the code using external builder 40. The compiled code is then placed into the appropriate location within a staging directory maintained by a content deployment and replication engine 50. The placing of the code in this location is sufficient to instruct the engine 50 that the code should be placed in the appropriate location in environment A 28. The engine 50 is then instructed to deploy the code, which causes the code to be deployed in environment A 28. The system 10 of the present invention assigns a release number to manifest 62, in this case release 1 since it is the first deployment to environment A 28. The code changes made to environment A 28 are stored in a database within system 10 along with this release number. Assuming that this is the only code in environment A 28, release 1 of this environment 28 comprises version 1 of code A, B, and C, as is shown in FIG. 2a.

In FIG. 2b, a second manifest 64 is issued to system 10. This manifest 64 specifies that version 2 of code A and C should be deployed to environment A 28. This is handled by the system 10 in the same way as manifest 62 was handled, resulting in versions 2 of A and C being deployed to environment A. The system 10 assigns a release number to this manifest 64. In this case, release number 2 is assigned, although there is no requirement that subsequent releases be numbered sequentially. As shown in FIG. 2b, release 2 of environment A 28 contains version 2 of code A and C, and version 1 of code B. Similarly, manifest 66 in FIG. 2c results in release 3 to environment A, with code A being updated to version 3 and code B being updated to version 1.1.

By tracking the changes to environment A 28 as separate releases, the present invention system 10 can easily handle rollback requests. For instance, the changes made in release 3 of environment A 28 may have caused environment A 28 to malfunction. An administrator may desire to rollback environment A 28 to a previous release. This is accomplished via a rollback request 68, which specifies the environment 20 and the target release. In this case, rollback request 68 requests that environment A be rolled backed to release 2. The system 10 can check its database to determine the differences between release 3 and release 2. Noting that code A and B have changed, the system can check out the appropriate versions of code A and B from the repository 30 and deploy that code to environment A 28. Code C was not changed, and therefore would not need to be redeployed. This results in environment A 28 being returned to the state of release 2, as shown in FIG. 2d. The system may track this as a return to release 2, or alternatively could label this a new release, such as release 4.

It would also be possible to specify a target release that is not a prior release of the current environment 20. For instance, where a testing 24 and a production environment 26 exist, such as shown in FIG. 1, it may be desirable to make the testing environment 24 coincide with the current state of the production environment 26. All that would be necessary is for the rollback request 68 to specify that the testing environment 24 should be rolled back to the current release of the production environment 26. This type of rollback might bring the testing environment 24 into a state never before experienced by the testing environment 24. Hence, the new state after the rollback would be assigned a new release number by the software building and deployment system 10 of the present invention.

3. Components of System 10

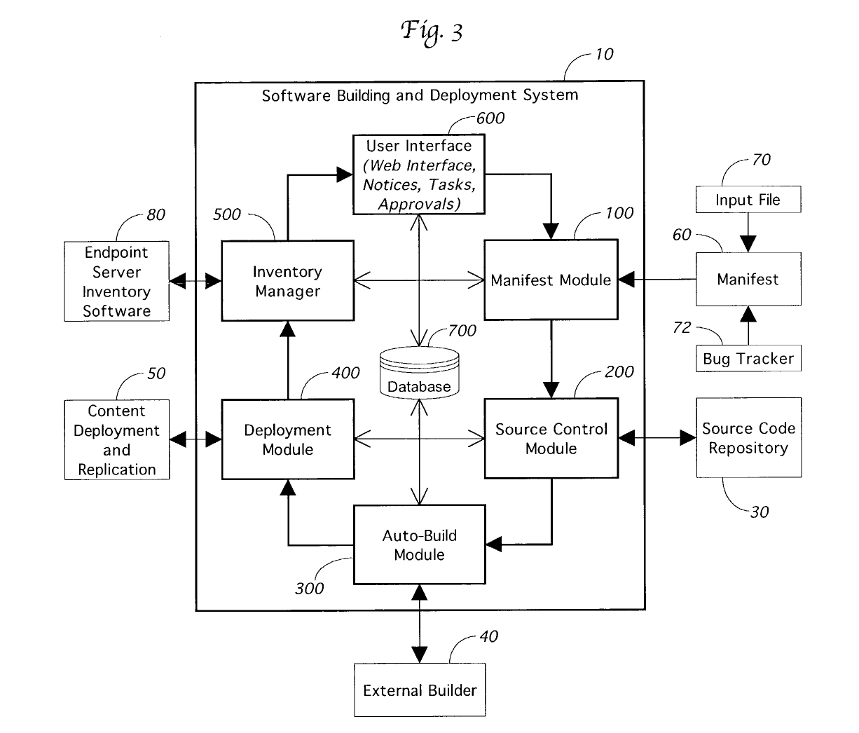

FIG. 3 shows the primary components of the present invention 10. As was shown in FIG. 1, the system 10 receives instructions from a manifest 60, connects to a source code repository 30, interacts with an external builder 40, and submits code to a content deployment and replication engine 50. The present invention system also utilizes endpoint server inventory software 80 running in the particular environments 20 to help maintain inventory control. This software 80 is specially designed to operate with the present invention system 10, and is capable of analyzing the current file contents of the servers 21 on which the software is deployed.

The primary modules of the present invention system 10 are the manifest module 100, the source control module 200, the auto-build module 300, the deployment module 400, the inventory manager 500, and the user interface 600. Each of these modules utilizes a central database 700 to store and retrieve data. In the preferred embodiment, each module operates on a programmable computer system such as a personal computer, workstation, or mini computer. The modules are preferably software constructs, and may take the form of independently programmed procedures or objects, or may alternatively be only logical/functional divisions in a single programming structure. Although the preferred embodiment operates the modules on a single computer system, it would be obvious to one of ordinary skill that these modules could operate on a plurality of systems and communicate with each other and the database 700 over a communications network or bus. It would also be obvious to one of ordinary skill that the modules of FIG. 3 represent only one possible way of logically dividing the present invention system 10 into modules. Other divisions would certainly be possible, and are well within the scope of the present invention. The following description will first briefly describe all of the modules, then explain the structure of the database 700, and then provide a detailed description of each module in turn.

As explained above, the manifest 60 determines what files are being changed in a particular release of an environment 20. The manifest may be the output of a hand-generated input file 70 or a change or “bug” tracking tool 72. The manifest module 100 is responsible from receiving the manifest 60 from the input file 70 or bug tracking tool 72. The manifest module 100 will assign a unique ID (or release number) to the changes set forth in the manifest 60. This ID will be used by all of the other modules and will also be used for reporting and rollbacks. The manifest module 100 is also responsible for updating the database 700 by creating a new release record for each manifest 60 received.

The source control module 200 is responsible for interfacing with one or more source code repositories 30. This module 200 has the ability to both checkout materials from and check materials into a repository 30. The check-in function is used by the present invention 10 to allow the source code module 200 to check-in code that is compiled by the auto-build module 300, as is described below.

The auto-build module 300 is responsible for building components in a release that need compilation. The resulting compiled code is checked back into the source code repository 30 in case it is needed for restoring an environment on rollback. This module 300 is also capable of responding to build dependencies for interrelated components. This allows related components needing recompilation to be compiled in the correct order, whether or not they are contained in the current manifest 60.

The present invention system 10 does not move code to the servers 21 of the target environment 20. Rather, the deployment module 400 places code and content received from the source control module 200 and the auto-build module 300 in the deployment or staging directory of a content deployment and replication engine 50. The deployment module 400 then instructions the content deployment and replication engine 50 to deploy the code found in its staging directory.

The inventory manager 500 is responsible for ensuring that the servers 21 of the target environment 20 have successfully received the code deployed through the deployment module 400. This is accomplished by maintaining a hash, such as a CRC value, in the database 700 for each file that is deployed out to an environment 20. In this way, the inventory manager 500 can request that the endpoint server inventory software 80 operating in the target environment create its own hash values for the files on one or more servers 21. The inventory manager 500 can then compare the values returned by the endpoint server inventory software 80 with the hash values stored in database 700. Errors can be reported to administrators, or the inventory manager 500 can initiate a redeployment of a release.

The user interface 600 is primarily composed of a web interface, a notice or e-mail interface, and an approval/task interface. The web interface can provide access to environment file inventories and provide detail information about each file and release from the database 700. The notice interface is used to communicate error and status information to administrators of the system. The task interface allows the system 10 to organize releases into tasks much like a rudimentary workflow management system.

4. Database 700

The final component shown in FIG. 3 is the database 700, which is responsible for maintaining all data concerning the files deployed by system 10. This database 700 is responsible for maintaining an inventory of all files on each server 21 in an environment 20. The inventory must be release specific, so that all of the files in every release of an environment 20 will be known by the database 700. More specifically, each release will contain a list of all files, including the file versions and a link to the exact source code within the repository 30 that was used to create that file. This allows the system 10 the ability to exactly replicate a production environment 26 on a testing 24 or development environment 22, as well as the ability to quickly and easily rollback any environment 20 to a preexisting release.

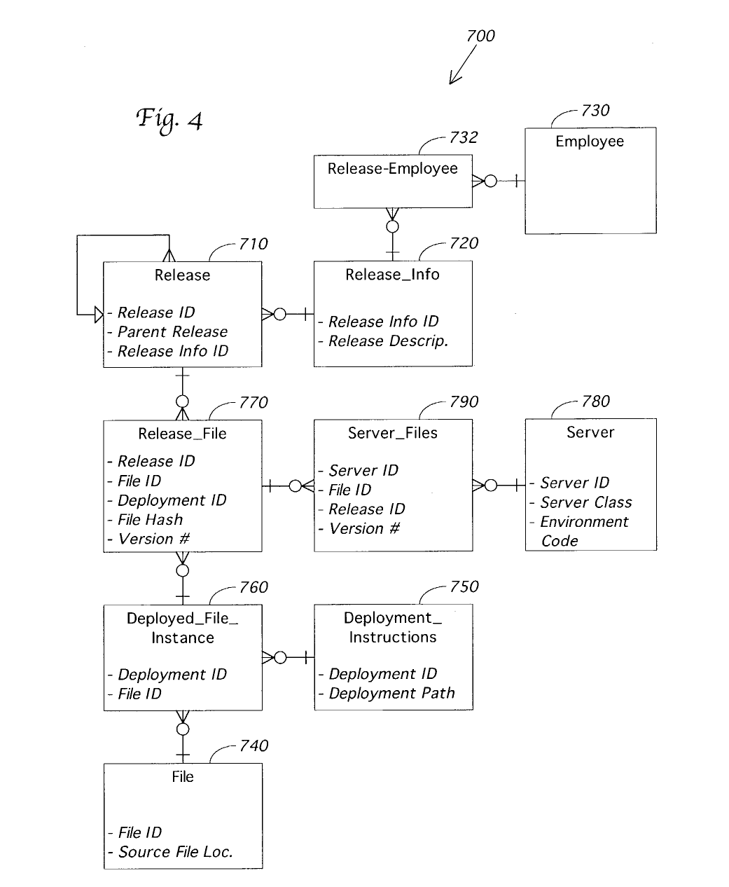

This is accomplished in the preferred environment by using a relational database structure that is shown in part in FIG. 4. One of the primary components of this database is the release file 710, which contains a separate entry for each manifest 60 received by the system. Each release entry has a release ID to uniquely identify the release in the system 10. The release 710 also contains a parent release ID to identify the parent for each release, and a release info ID to associate each release record 710 with a release_info record 720 in a many-to-one relationship. This allows groups of releases 710 to be identified with a single release_info record, which contains a description that applies to all of its related release records 710. The database 700 also contains employee records 730, which are associated with a release_info 720 group of releases 710 through release_employee 732.

Each file is recorded in the database 700 as a separate file record 740, which contains a file ID and a source file location. The source file location indicates where the source for this file is found in the source code repository 30. When a file is deployed by the system 10, it is deployed to a particular deployment path. This is recorded in database 700 through a deployment_instructions record 750 that contains a deployment ID and a deployment path. The database 700 also uses a deployed_file_instance record 760 that links a particular file ID with a particular deployment ID.

One file may be deployed in multiple locations, meaning that one file record 740 may be associated with many deployed_file_instance records 760. Similarly, multiple files may be deployed along a particular path; so multiple deployed_file_instance records 760 can be associated with a particular deployment instructions record 750.

When a file is included within a release, a release_file record 770 is created. This record is associated with a particular release by containing a release ID, meaning that a single release can be associated with many released files. The release_file record 770 also contains a file ID and a deployment ID, allowing the released file to be associated with a particular instance of a deployed file. One deployed_file_instance record 760 can be associated with multiple release_file records 770, mirroring the fact that many versions of the same file can be deployed to the same location over multiple releases. The release_file record 770 also contains the version number of the file deployed in a particular release, as well as the hash value obtained by the system 10 before the file was deployed. It is this hash value that is used by the inventory manager 500 to confirm that the contents of the servers 21 conform to the database 700.

Finally, the database 700 tracks multiple servers in server records 780, each of which contains an environment code to associate the server with a particular environment 20 and a server class identifier. The individual files on a server are recorded in server_file records 790, which are linked to a particular server through a server ID. The server_file records 790 are also linked to a particular release_file record 770 via a file ID, release ID, and version number. One instance of a released file in record 770 can be associated with multiple server_file records 790 since a single release of a file version to an environment 20 may result in the file be deployed to multiple servers 28 within that environment 20.

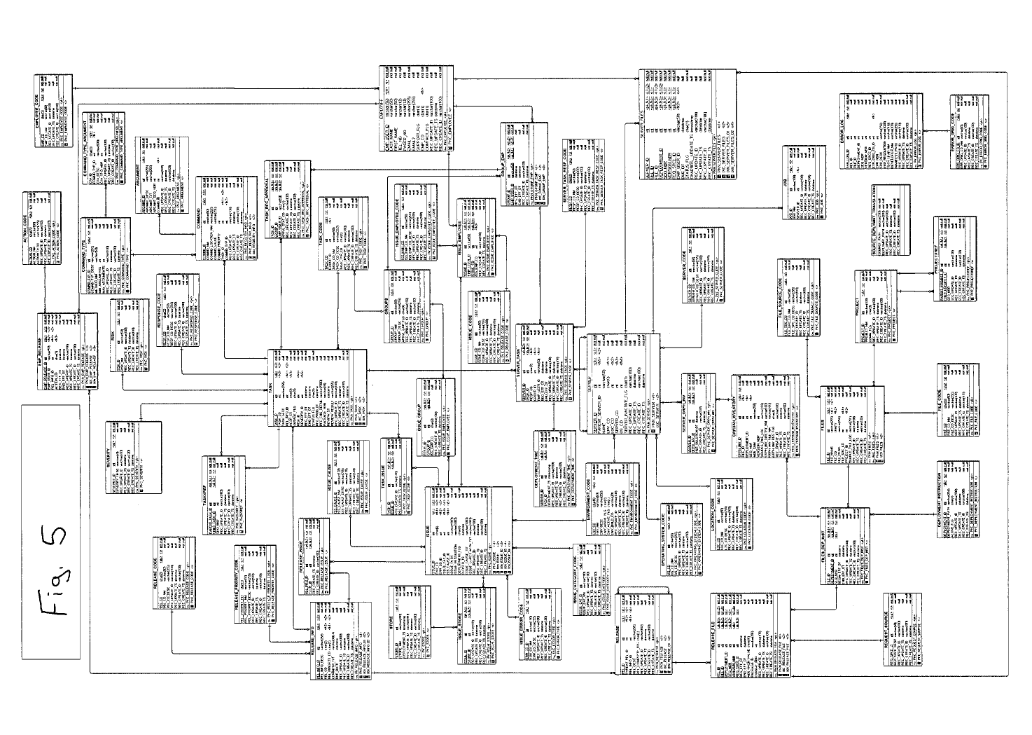

FIG. 4 shows the primary data tables that are used to implement the database 700 in the preferred embodiment of the present invention. FIG. 5 shows the same embodiment of the database 700 in additional detail. This preferred embodiment is only a single way among many that can be used to implement database 700. Persons of ordinary skill in the art would recognize numerous ways to organize the data maintained by database 700 to meet the purposes of the present invention.

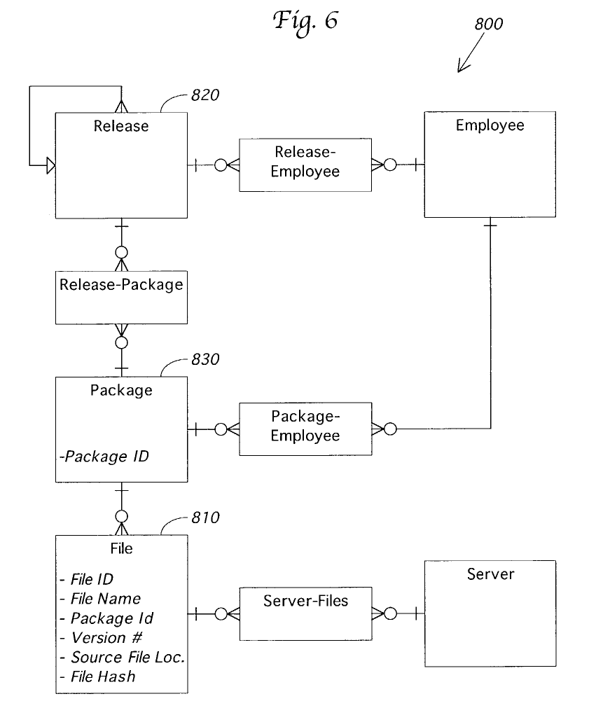

One alternative embodiment 800 of database 700 is shown in FIG. 6, which shows a simplified version of the data structures of FIGS. 4 and 5. In FIG. 6, a single file table 810 is used to store a file ID, file name, package ID, version number, source file location, and a hash value. This single table 810 replaces the file 740, deployment_instructions 750, deployed_file_instance 760, and the release_file 770 table, although it does so by maintaining less information (such as the deployment path) and fewer relationships (such as the relationship between a single file and multiple deployed file instances). In addition, embodiment 800 shows the release table 820 being associated with multiple packages 830, with each package containing multiple files 810, as opposed to each release 710 being associated directly with multiple release_files 770.

5. Manifest Module 100

The manifest module 100 interacts with a manifest 60 that is created as an input file 70 or retrieved directly from change or bug tracking software 72. Alternatively, the manifest could be obtained via user interface 600 such as through a web interface. The key contents of the manifest 60 are shown in FIG. 7, which reveals that each manifest 60 must indicate the target environment 61 that the manifest 60 desires to change. The manifest 60 also should contain a description 63 of the changes to be made by manifest 60, such as “bug fix for e-commerce credit card check module.” Finally, the manifest 60 should contain a list of the changes 65 that are requested by the manifest 60. Each change 65 might be associated with a bug or change number 67 taken from software 72, and an employee 69 responsible for this change. Each change 65 will also contain one or more files or packages 71 that are to be deployed. Name, source path, and version number uniquely identify the files 71, and allow the manifest module 100 to retrieve the file 71 from the source code repository 30. It would also be possible to explicitly specify the deployment path for each file within the manifest 60. The manifest 60 is also able to specify that certain files within an environment 20 should be deleted. When a file is removed, the database 700 maintains a historic record of the file, allowing the deletion to be rolled back through a rollback instruction 68.

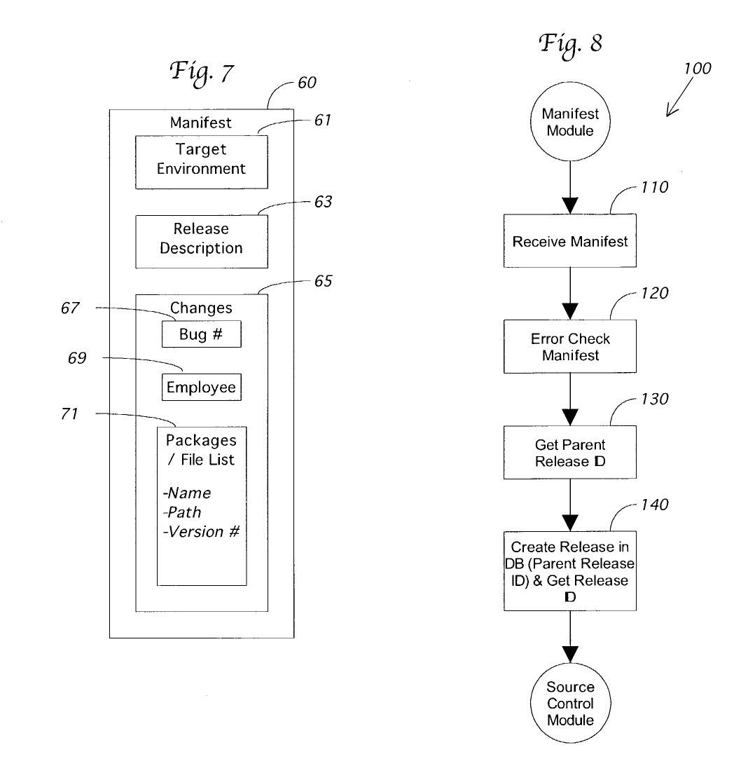

The manifest module 100 receives the manifest 60 for system 10. The functionality of this module 100 is shown in the flow chart of FIG. 8. The first step 110 is to receive the manifest 60, which can be accomplished by retrieving a file 70, interfacing with the API of bug tracking software 72, or receiving inputs from the user interface 600.

The present invention checks the manifest 60 for errors in step 120. The actual error checking will ideally occur at multiple points in system 10, including when the manifest 60 is first read 110 and when the source code specified by the manifest 60 is analyzed. The purpose of this error checking is to avoid deploying manifests that don't make sense given the history of the environment, as is known by the database 700. Manifests 60 are checked for duplication, to make sure there are not multiple instructions to deploy the same versions of software, or so that versions are not requested for deployment that already exist in an environment 20 The code specified by a manifest 60 is also examined to make sure that the date of the specified code is not older than the code already in the environment (or that the version number indicated in the manifest 60 isn't lower than the version number already in the target environment 61). If an error is discovered, the preferred embodiment halts the deployment of the manifest and sends a notice to an administrator through the user interface 600.

The database 700 is accessed by the manifest module 100 to determine the release ID for the parent release of this manifest 60 in step 130. In the preferred embodiment, the parent release is the release that currently exists in the target environment 61. Once the parent release ID is obtained, the manifest module 100 creates a new release record 710 in the database 700 in step 140. The process of creating a new release record 710 will return to the manifest module 100 a release ID for this manifest 60, which will be used by the remaining modules of system 10. Alternatively, the release number could be specified in the manifest 60, in which case the release number would be submitted to the database 700 for inclusion with the created release record 710. At this point, the manifest module 100 has completed its work and the data in the manifest 60 is presented to the source control module 200.

6. Source Control Module 200

The source control module 200 performs the extraction and parsing of code components from the source control repository 30. The module 200 helps to develop the mapping between the source locations in repository 30 and the deployment locations in the environments 20. A single input file can have multiple destinations within one or more environments 20, so the present invention is capable of storing multiple destinations for each source file. The source control module 200 may be specially developed to interact with a single source code repository 30, such as VSS or Harvest. Alternatively, the module 200 may be developed more generically, with the ability to interact with multiple repositories 30. Since each repository 30 will have a different mechanism for such access, the present invention utilizes a “universal translator” component that handles most of the translations between the repository 30 and system 10, with vendor specific interfaces being confined to code that exists between the universal translator and the specific repository 30.

Generally, the source code repository 30 can contain uncompiled source code as well as content files that do not need compilation. In addition, it is possible for the repository to contain binary components that are already compiled. The present invention treats these files as “third party” modules, and is capable of deploying such compiled binary files to an environment without having to be compiled by the auto-build module 300. The source control module 200 contains rules that determine the existence of third party components. If a binary file is tracked as a third-party component, the present invention will obviously not have the ability to track the source code used to compile that component.

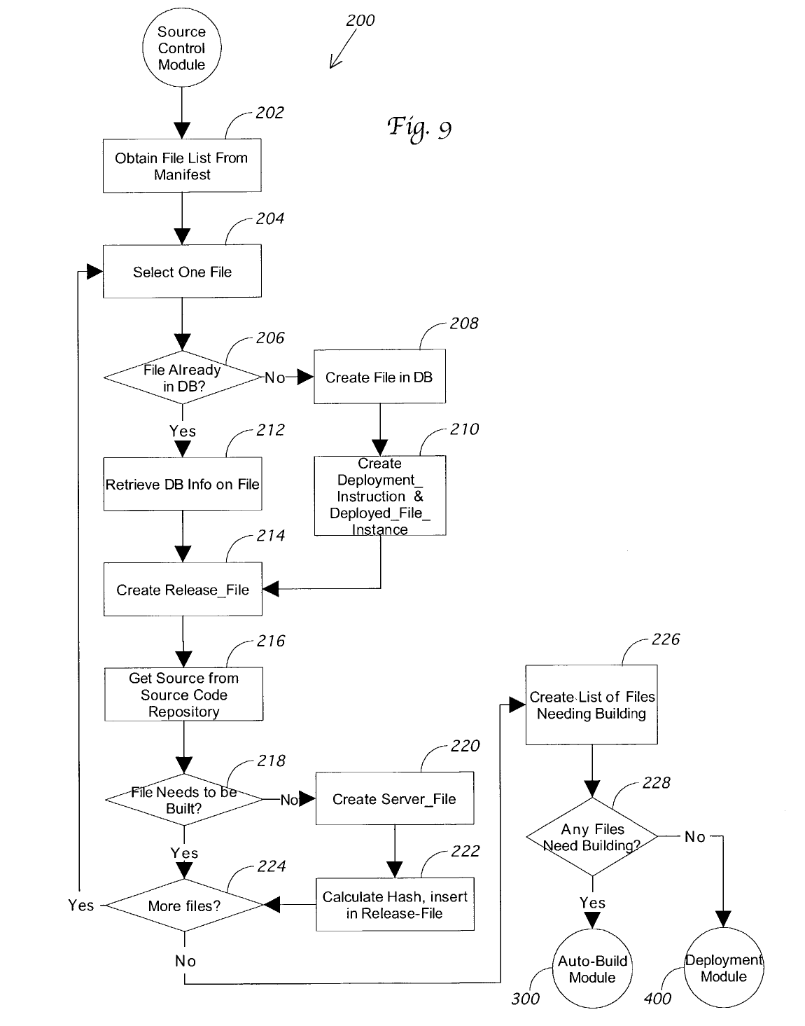

The process used by the source control module 200 to perform its operations is set fourth in FIG. 9. The first step 202 in this process is to obtain from the manifest module 100 a list of files to retrieve from the source code repository 30. One file is selected from this list in step 204, and then the database 700 is queried in step 206 to determine whether the selected file is already located in the database 700. If not, step 208 creates a new record in file table 740 using the file name and source file location. Next, step 210 creates a deployment instruction entry 750 and a deployed_file_instance entry 760, which also returns the deployment ID.

If the file was found in the database 700 in step 206, then step 212 will retrieve information about the file and its prior deployment, including the file ID and deployment ID. After step 210 or 212, the process continues at step 214, where the source control module 200 creates an entry in release_file record table 770. This entry includes the release ID, file ID, deployment ID and version number for the file, thereby indicating that this version of the file will be will be deployed to a particular deployment path as part of this release.

The next step 216 then retrieves the file contents from the source code repository 30. Step 218 then determines if this particular file is source code that needs to be compiled, or whether this is either an already compiled binary file or content that does not need to be built.

If the file does not need compilation, step 220 creates an entry in the server_file table 790, indicating that this file will be located on a particular server 21. This table entry 790 includes the server ID (which can be obtained by analyzing the deployment path), the file ID, the version of the file, and the deployment ID. Since the file will not need to be compiled before deployment, the hash or CRC value for the file can be calculated at this point, which is accomplished at step 222. CRC values can be generated in a number of ways. For Windows platforms, the preferred embodiment uses a MD5 hash value created using Microsoft CryptoAPI in the Platform SDK. For Java, the preferred embodiment uses the java.util.zip package that contains the CRC32 class. Though these mechanisms for CRC values will be platform-specific, using pre-built interfaces minimizes the testing requirements and allows for rapid upgrading during the future. For each of these algorithms, the chance that the 128-bit value will be duplicated is approximately 1 in 4,000,000,000 (specific stats vary slightly between methods). In order for this calculated value to be associated with the correct version of the file in the database 700, step 222 inserts the calculated hash value in the newly created release_file record 770. Finally, step 224 determines whether there are any more files in the list received from the manifest, and if so, returns processing to step 204 to select the next file.

If step 218 determines that the file does need to be compiled before it is deployed, the server file 770 will not be created and the CRC value will not be calculated until after compilation. Instead, following step 218, source module 200 goes directly to step 224 to determine if there are any more files in the file list.

If step 224 determines that all of the files in the manifest have been analyzed, the source code module 200 will create a list of files that need to be built in step 226. The module 200 then checks to see if any files exist on the list of to-be-built files in step 228. If so, source code module 200 initiates processing of those files via auto-build module 300. If no files need to be compiled, the auto-build module 300 is skipped and the deployment module 400 is activated immediately.

7. Auto-Build Module 300

The auto-build module 300 includes interfaces to one or more external builders 40, such as Microsoft Visual Basic and Visual C++ compiler. The interface is a wrapper on the Visual Studio toolset, allowing projects to be compiled in the automated system using the project files in the same manner that the developers of the code did testing. This process supports maintaining binary compatibility between versions of COM components when appropriate. When an application requires breaking binary compatibility, the developer can specify the version of the component that the auto-build module 300 should refer to for the new compatible component. Finally, the interface of the auto-build module 300 allows the packaging of COM+ components (creation of the .msi and .cab files). In developing this interface, the developers of the preferred embodiment of the present invention determined that it is better to avoid maintaining makefiles to keep the deployment process in sync with the development process.

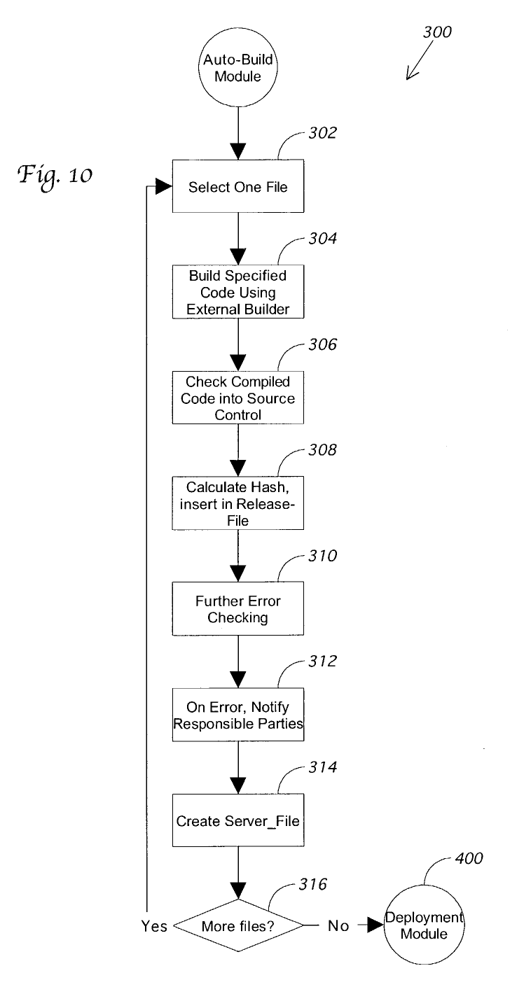

The auto-build module 300 accomplishes its functions using the process set forth in FIG. 10. The first step 302 in this process is to select a single file from the list of files to be built that was created by the source control module 200. Next, the appropriate external builder 40 builds this selected file in step 304. At step 306, the compiled code returned by builder 40 is checked back into the source code repository 30 using the source control module 200. By checking the compiled code back into the repository 30, this code can be accessed at a future time, such as during a rollback to an earlier version. If the code were recompiled during a rollback, changes to the external builder 40 may result in changes being made to the compiled code. This would be counterproductive to one of the primary the goals of the present system 10, which is to allow easy rollbacks to the exact state that the environment 20 was in during an earlier release.

The auto-build module 300 also creates a CRC or hash value for the compiled code in step 308. This value is inserted into the release_file record 770 for this file, much like was done for non-compiled code at step 222. FIG. 10 then shows that the auto-build module 300 engages in further error checking on the compiled code (step 310). This could include checking for compilation errors, as well as backward version collisions (whether the current release has files going backwards in version) and “squashes” (checking all files for the current release ID and seeing what files differ within a given environment). This type of error checking is similar to the error checking indicated at step 120 in FIG. 8. Many similar error checks can be performed in the system 10 of the present invention, whose purpose is to prevent code being deployed into an environment that would cause the environment to function improperly. Encountered errors are communicated to one or more administrators through the user interface 600 in step 312. Finally, the auto-build module is also responsible for creating the server_file for the file after it has been successfully built, which is shown in FIG. 10 at step 314.

Step 316 then checks to determine if any more files need to be built. If so, processing continues at step 302. If not, the deployment module 400 is initiated.

8. Deployment Module 400

In the preferred embodiment, the deployment paths stored in database 700 represent locations on the various server classes within an environment 20. Thus, the deployment instructions 750 associated with each release file can provide the deployment module the exact locations in an environment 20 where a file should be deployed. Once packaged, the deployment module 400 picks up the component and determines which jobs need to be executed. The appropriate interfaces to the content deployment and replication engines 50 are then called to execute those jobs. This allows a consolidated manifest 60 with files that are deployed to disparate servers 21. In the preferred embodiment, installation routines on the target servers 21 have focused on the Microsoft suite of products, including application shutdown, COM/COM+ registration, registry changes, etc. Other instances are also well within the scope of the present invention.

The deployment module 400 has the capability to deliver stored procedures to RDMS systems, such as SQL Server or Oracle databases. In this process, the assets are promoted and deployed as other files, but are placed in special directories in the target environment 20. Once in place, a stored procedure deployment component can install them to the target databases.

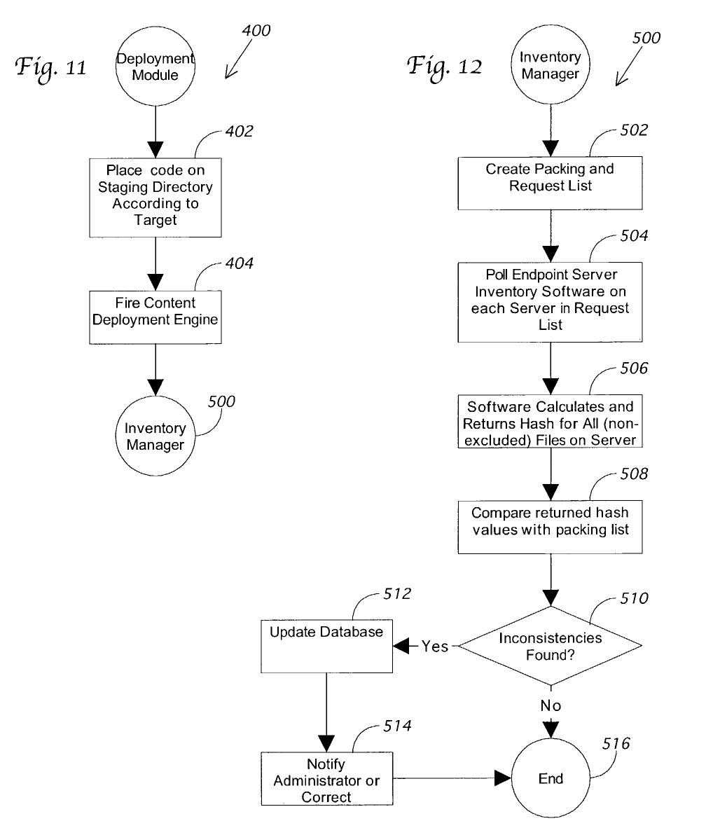

The process utilized by the deployment module 400 is straightforward, in that it depends heavily on the content deployment and replication engine to handle the details of component deployment. This process is shown in FIG. 11, and starts with the step 402 of placing each component/file that is to be deployed in the appropriate location of the staging directory used by engine 50. The database 700 conveys all the information needed by module 400 to determine the deployment location. After the files to be deployed are placed in the staging directory, the content deployment and replication engine 50 is then fired in step 404, which causes those files to be deployed into the servers 21 of the target environment. The deployment module 400 then summons the inventory manager 500 to verify the inventory of the target environment 20.

9. Inventory Manager 500

The inventory manager 500 is responsible for validating that the files found on individual servers 21 are the same files that are indicated by the database 700. This is possible because the source control module 200 and the auto-build module 300 automatically compute CRC values for each file deployed through the system 10. The way in which these values are used in the preferred embodiment to validate the inventory of the servers 21 is shown in the process of FIG. 12.

The first step 502 in this process is to create a request list and a packing list. The request list specifies which servers 21 the inventory manager 500 should analyze. In the preferred embodiment, the inventory manager 500 is called after every deployment of a release by the deployment module 400. Consequently, the default request list will contain all of the servers 21 that should have been altered in the just deployed release. During busy times, this request list can left empty, which has the effect of completely shutting down the inventory process of the inventory manager 500. The packing list contains a list of CRC values for every file found on the servers 21 indicated in the request list.

When the inventory manager 500 receives the request list, it polls the endpoint server inventory software 80 found on each of the servers 21 listed in the request list, which is shown as step 504 in FIG. 12. In the preferred embodiment, this software 80 is found on every server 21 within an environment. However, it would be obvious to one of ordinary skill that the inventory software 80 could operate on a single server 21 that accesses and evaluates files on one or more other servers 21.

The endpoint server inventory software 80 is responsible for calculating a hash (such as a CRC) value for every file on the server 21. On Windows machines in the preferred embodiment, this software 80 will be a COM component accessed via an ASP page. The request will be passed as a query string (in the URL). The ASP page will instantiate the COM component that determines the CRCs for the requested files. The COM component then returns the calculated CRCs to the ASP page for an encrypted response back to the inventory manager 500 (step 506). To maintain security, the ASP page is available only to the inventory manager 500, and is locked down by requiring a client certificate.

By default, the endpoint server inventory software 80 calculates and returns a CRC value for every file located on the server 21. However, the preferred embodiment includes the ability to specify files and directories that are to be excluded from the analysis. This allows the system 10 to ignore files on the servers that are not deployed and managed by the system 10. It would be equally possible to have the software 80 analyze only files that are specifically requested by the inventory manager 500. This would allow the inventory manager 500 to request the CRC values for only those files that should have been altered by a recent deployment by the deployment module.

When the inventory manager 500 receives the list of CRC values back from the endpoint server inventory software 80, those values are compared to the CRC values in the packing list in step 508. If inconsistencies between those values are found in step 510, the inventory manager 500 is responsible for updating the database 700 to reflect the current state of the server 21 (step 512). These inconsistencies are then reported to an administrator in step 514. Alternatively, the inventory manager 500 can be tasked with ensuring that the servers 21 in an environment match the current status in database 700. In this case, the inventory manager could create a manifest 60 that would bring the server back in line with the status shown in the database 700. This manifest would then be sent to the manifest module, which would begin the process of deploying the code necessary to correct the server 21. If there are no inconsistencies found, the inventory manager stops processing at step 516.

10. User Interface 600

The primary user interface 600 of the present invention is the web interface, which is designed to allow administrative access to the system 10 and its database 700. This interface 600 will allow a user to schedule and monitor deployments and rollbacks. In addition, since the system has its own interface with one or more source code repositories 30, the web interface could provide users direct access to the code and components stored in the repositories 30. This web interface can be used to initiate, monitor, or halt any action of any of the other major components 100-500 of system 10, such as initiating the processing of a manifest 60, controlling the building of code by the auto-build module 300, or canceling a deployment by the deployment module 400. The interface is highly useful for creating and receiving reports generated by the system 10. It would even be possible to use the web interface to develop a manifest 60 for use by the manifest module 100, such that the module 100 would not have to interact with an external input file 70 or bug tacking software 72. Access to the system 10 through the web interface is governed by a variety of login and security methods, which are well known in the prior art. The preferred embodiment places especially high security restrictions on any access relating to the production environments 26 maintained by the system 10.

The user interface 600 also contains a messaging capability that can send alerts or notices to designated parties with regard to approvals, build execution, deployment success or failures, and work status. The user interface 600 can be used as part of a task-oriented workflow management system. Approval tasks can be assigned to administrators, requiring some or all manifests to be approved by administrators before being processed by the system 10. For instance, all manifests that intend to create a new release to a production environment 26 may need approval from a high-level administrator before the manifest module 100 begins processing the manifest 60. In the preferred embodiment of the present invention, employees are grouped according to responsibilities, and tasks can be assigned to a particular group of employees. The approval/task interface allows users to view outstanding tasks, to perform work on those tasks, and to grant permission for certain activities. The actual interface used in this context is similar to those found in prior art workflow management systems, and is not a central part of the present invention.

11. Automated Rollback

The present invention system 10 is designed to perform automated rollbacks in a simple and straightforward manner. The system 10 can rollback an environment 20 to a variety of conditions, such as to a previous release experienced by that environment 20, or, in the context of a development or testing environment 22, 24, to the current release of the related production environment 26. The system 10 is also capable of rolling back individual packages (if supported in the manifest) or rolling back a full manifest 60. The system 10 will manage “stacked” releases, where changes to a single file have taken place in different environments 20 (which may happen with multiple environments 20 co-existing on a single server 21). When a rollback occurs, if the file has been replaced by another file in a different environment 20, the file will not be affected. The database 700 also supports “rolling forward”, to put a rolled back manifest 60 back in place.

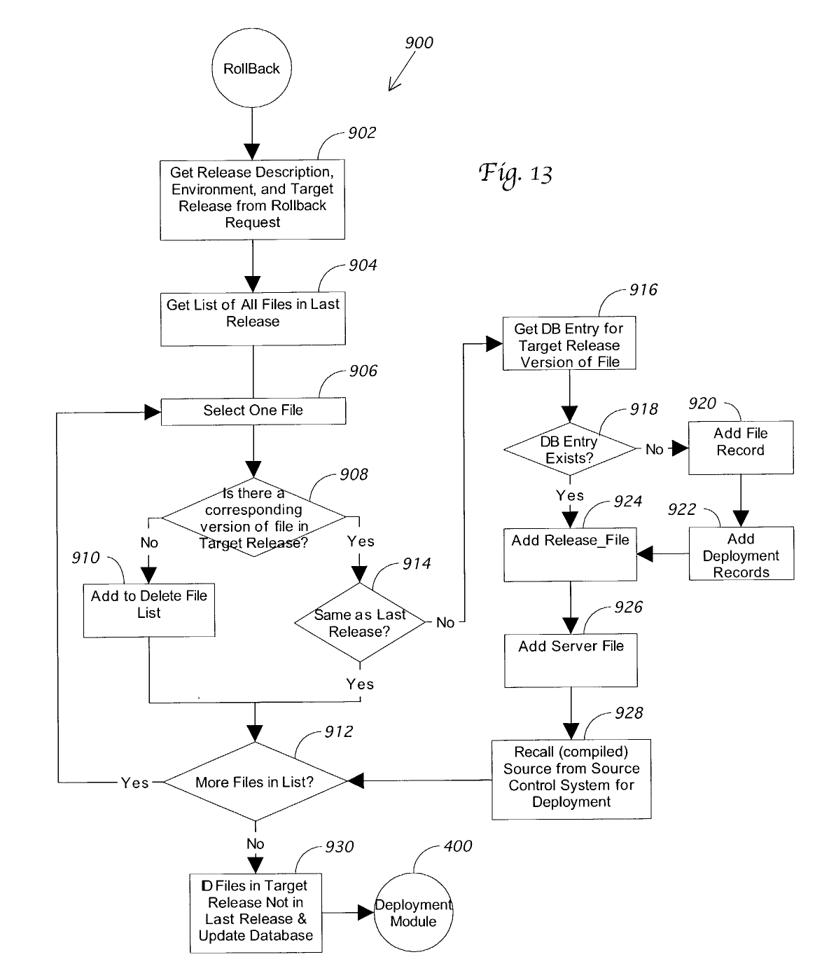

The process 900 used by the present invention system 10 for performing a rollback is shown in FIG. 13. The first step 902 is to obtain the release description, environment 20, and target release from a rollback request. This information explains exactly what environment 20 is to be rolled back as well as the intended condition of the environment 20 after the rollback. In one possible embodiment, a rollback can affect only a subset of code in a release. In this embodiment, the rollback request should specify the affected code.

Step 904 then queries the database 700 to obtain a list of all files in the current release of the specified environment 20. One file from that list is selected in step 906. The target release of the environment 20 is then examined to determine whether that file exists in the target release, which occurs at step 908. If the file does not exist in the target release, then that file must be deleted during the rollback, so it is added to the delete file list in step 910. Step 912 then examines if any more files remain unexamined, and, if so, would return processing to step 906.

If step 908 determines that the file in the latest release of the environment will continue to exist in the target release after rollback, then the versions of the files are compared at step 914. If the versions of the file in the current release and the target release are identical, processing of additional files merely continues at step 912—indicating that no rolling back is necessary for this file.

If step 914 determines that the file versions are different, then step 916 examines the entries in database 700 related to the target release version of the file at step 916. Step 918 verifies that an entry for that file was found in database 700. If not, then the database 700 must be altered to include a record for that file. More specifically, a file record 740 is created in step 920, and a deployment_instructions record 750 and deployed_file_instance record 760 are created in step 922. Finally, a release_file record 770 and a server_file record 790 are added in steps 924 and 926. If step 918 found that a database entry does exist for the file, steps 920 and 922 are skipped, but a release_file record 770 and a server_file record 790 are created. Each of these records reflect that the rollback request will change the current release of the environment 20, and therefore these changes to the database 700 will utilize the release ID appropriate for the rollback release. It is not necessary to delete any entries in the server_files table 790 or the release_file table 770 for the version of the file to be replaced during the rollback, since all such records are inherently tied to a particular release for the server 21.

Step 928 then recalls the content related to the file from the appropriate source code repository 30. In the preferred embodiment, no compilation will be required of this content, since the compiled version of any code that needed to be built will have been stored in the source code repository 30 in step 306 of FIG. 10. The system then continues at step 912 to determine if any more files need to be analyzed. If not, then step 930 analyzes all files that exist on the target release but were not found on the last release of the environment 20. Each of these files must be included in the deployment of this rollback in order to include all files on the environment 20 that existed in the target release. For each such files, steps similar to 916 to 928 will be required to update the database 700 and recall the appropriate content from the source control system 30. Once this is accomplished, the deployment module 400 is initiated and the rollback is completed like any other release.

12. Example Implementations

There are numerous ways in which the above invention could be implemented in an actual programming environment. In the preferred embodiment, one programming construct or procedure is called to handle the combined functions of the manifest module 100, source control module 200, the auto-build module 300, and the deployment 400. However, separate versions of this procedure are called depending upon whether the manifest 60 relates to a “service pack” or a “release deployment.” A service pack relates to content-only changes, such as new content being submitted to a web-site-related environment 20. A release deployment relates to a manifest 60 that makes functional changes to an environment 20. One difference between these types of deployments is that a service pack does not call the auto-build module 300 since no code needs to be compiled in a content-only change.

This specification includes a computer program listing appendix submitted on a compact disc, containing the files Release.txt, Rollback.txt, and ServPak.txt. The file ServPak.txt shows sample code and descriptive commentary for the procedure used by the preferred embodiment for the service pack implementation. Similarly, the file Release.txt shows sample code and commentary for the release deployment. Rollback.txt contains sample code and commentary for a rollback deployment as implemented in the preferred embodiment.

The invention is not to be taken as limited to all of the above details, as modifications and variations may be made without departing from the spirit or scope of the invention. For instance, each of the modules 100-500 were described in the context of a particular process shown in the Figures. Minor changes to the order of the individual steps could be accomplished without any significant change in the scope and effectiveness of the present invention. In addition, the above description described database 700 in the context of a particular relational database made up of a plurality of related tables. It would be well within the scope of present invention to alter the particular tables and relationship of the database, such as was illustrated in the alternative shown in FIG. 6. It would be further possible to implement the database 700 in an entirely different structure, such as in an object-oriented environment. As the above examples illustrate, the invention should not be limited by the specifics of the above description, but rather should be limited only by the following claims.

What is claimed is:

1. A method of deploying a plurality of files to an environment causing a change in the environment, the method comprising the steps of:
a) receiving a manifest containing a list of the plurality of files specific as to a version for each file, the manifest further containing an identification of the environment;
b) creating a release record in a central database, the release record containing a release ID identifying the change in the environment caused by the deployment of the plurality of files as a unique release of the environment;
c) obtaining the plurality of files from one or more repositories, including a set of files that requires compilation before deployment;
d) submitting the set of files to an external builder resulting in compiled files;
e) creating a files entry in the central database for each file to be deployed, each entry containing
i) a version indicator representing the version of the file,
ii) an identifier uniquely identifying the environment, and
iii) the release ID;
f) deploying the compiled files to the environment.

2. The method of claim 1, wherein the central database is a relational database management system.

3. The method of claim 2, wherein the files entry in the central database is performed by making entries into multiple tables in the central database.

4. The method of claim 3, wherein the files entry in the central database comprises an entry in a released files table identifying file versions included in the release and an entry in a files table identifying the location of the file in the one or more repositories, whereby the database is able to link each released file in a particular version of the environment with the source of the file in the repository.

5. The method of claim 1, wherein the central database is an object-oriented database, and further wherein the files entry in the central database is performed by instantiating an instance of a files object in the central database.

6. The method of claim 1, further comprising the step of creating a hash of each file deployed to the environment, wherein the hash value is stored in the files entry in the central database.

7. A system for deploying a plurality of files to an environment causing a change in the environment, the system comprising:
a) a central database having a plurality of release records and a plurality of file entries, the release record containing a release ID identifying the change in the environment caused by the deployment of the plurality of files as a unique release of the environment, the file entry containing
i) a version indicator representing the version of the file,
ii) an identifier uniquely identifying the environment, and
iii) the release ID;
b) a manifest module programmed to receive a manifest containing a list of the plurality of files specific as to a version for each file, the manifest further containing an identification of the environment;
c) a source control module programmed to obtain the plurality of files from one or more repositories, including a set of files that requires compilation before deployment;
d) an auto-build module programmed to automatically submit the set of files to an external builder resulting in compiled files;
e) a deployment module programmed to place the compiled files in a staging directory for a content deployment engine and initiating the content deployment engine, thereby causing the compiled files to be deployed the environment.
